(19) United States
(12) Patent Application Publication
(10) Pub. No.: US 2023/0354097 A1
(43) Pub. Date: Nov. 2, 2023

(54) SYSTEM AND METHOD TO SEGMENT RECOVERY AND MESSAGE FEEDBACK IN 5G MESSAGING ARCHITECTURE

(71) Applicant: Samsung Electronics Co., Ltd., Suwon-si, Gyeonggi-do (KR)

(72) Inventors: Basavaraj Jayawant PATTAN, Bangalore (IN); Sapan Pramodkumar SHAH, Bangalore (IN)

(21) Appl. No.: 17/925,198

(22) PCT Filed: May 13, 2021
(86) PCT No.: PCT/KR2021/005977

§ 371 Date: Nov. 14, 2022

(30) Foreign Application Priority Data
May 13, 2020 (IN) 202041020201
May 5, 2021 (IN) 2020 41020201

(51) Int. Cl. H04W 28/06; H04L 47/34

(52) U.S. Cl. CPC H04W 28/06; H04L 47/34

(57) ABSTRACT

Embodiments herein provide a method for communicating messages between a source node and a destination node in an Internet of Things (IoT) network using a Fifth Generation (5G) Message (MSGin5G) Service. The method comprises receiving a data message from a source application. Further, identifying a maximum size of a payload supported by a destination node. Furthermore, segmenting the data message into one or more segments based on the maximum size of the payload and sending the one or more segments to the destination node. Thereafter, detecting whether a subset of segments are missing. Subsequently, performing at least one of a recovery of one or more missing segments and a re-assembly of the one or more segments to form the data message. Finally, sending a confirmation message to the source node indicating one of a successful reception or an un-successful reception of the data message.

### TECHNICAL FIELD

The present invention relates to a system and method for messaging in 5th Generation (5G) system and more particularly, it relates to segment recovery and message feedback in 5G messaging.

### BACKGROUND ART

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

In the recent times, providing communication service for Massive Internet of Things (MIoT) in 5G is increasing. The characteristics of MIoT devices includes high density connection, flexible mobility, saving power, limited computing capability, bulk of devices, and traffic pattern of short burst of small data. Further, the MIoT brings new demands on message communication, for example, light weight message communication for provision and monitoring, ultra-low latency and high reliability message communication for remote control, and extremely high resource efficiency for large scale connections. Today Short Message Service (SMS) is used as message enabler for some IoT applications. However, SMS has limitation in term of service capabilities (for example, 140 bytes payload) and performance (for example, long latency). In addition, the overhead of control plane resource is high. There have been enhancements and optimizations on the 3GPP network capabilities to facilitate IoT applications including device triggering, small data transfer, and Non IP Data Delivery (NIDD) and the like.

Therefore, as an alternative to SMS service, 3rd Generation Partnership Project (3GPP) defines a message service in 5G system called as MSGin5G Service for IoT devices. The MSGin5G Service enables various message communication models with advanced messaging service capabilities and performance over 5G system. Point-to-point, application-to-point, group and broadcast message communication models are supported in the MSGin5G Service. To meet the requirements of remote control, the MSGin5G Service needs to provide very low end-to-end latency and high reliability of message delivery. According to one of the requirement the MSGin5G Service is required to support variable size of payload of a text or data message with maximum 2048 bytes, and also support segmented transmission if the content is large than the maximum payload length of a message. If messages are not segmented before transmission, then there is a possibility that the target UE may not receive all messages. To make the transmission reliable, it is necessary to provide mechanism with segmented messages transmission along with necessary recovery.

Thus, it is desired to address the above mentioned disadvantages or other shortcomings or at least provide a useful alternative.

### DISCLOSURE OF INVENTION

### Solution to Problem

The principal object of the embodiments herein is to provide a system and method to segment recovery and message feedback in 5G messaging architecture.

Another objective of the embodiments herein is to provide a method for segmenting messages with a size larger than the maximum packet size of the access network.

Another objective of the embodiments herein is to provide a method for re-assembling the segmented messages.

Another objective of the embodiments herein is to provide a method for identifying a missing segment from the segmented messages.

Another objective of the embodiments herein is to provide a method for recovery of the missing segments.

Another objective of the embodiments herein is to provide a method for sending a feedback regarding a successful reception of the segmented messages or a failure to receive the segmented messages.

Accordingly the embodiment herein is to provide a method for communicating messages between a source node and a destination node in an Internet of Things (IoT) network using a Fifth Generation (5G) Message (MSGin5G) Service. The method comprises receiving, by a source node, a data message from a source application. Further, identifying, by the source node, a maximum size of a payload supported by a destination node. Furthermore, segmenting, by the source node, the data message into one or more segments based on the maximum size of the payload, wherein the one or more segments are sent to the destination node using the MSGin5G service. Upon receiving the one or more segments, detecting, by the destination node, whether a subset of segments from the one or more segments are missing. Thereafter, performing, by the destination node, at least one of a recovery of one or more missing segments in the one or more segments, and a re-assembly of the one or more segments to form the data message, wherein the data message is provided to a destination application. Finally, sending, by the destination node, a confirmation message to the source node indicating one of a successful reception or an un-successful reception of the data message using the MSGin5G service.

In an embodiment, the source node is a MSGin5G server when the source application is an application server and the destination node is a MSGin5G client of a IoT device-1 when the destination application is an application client.

In an embodiment, the source node is a MSGin5G client of a IoT device-1 when the source application is an application client and the destination node is a MSGin5G server when the destination application is an application server.

In an embodiment, identifying, by the source node, the maximum size of the payload comprises sending a query message to the destination node, wherein the query message comprises a request for the maximum size of the payload supported by the destination node. Further, receiving a response message from the destination node, wherein the response message comprises a value of the maximum size of the payload supported by the destination node.

In an embodiment, identifying, by the source node, the maximum size of the payload comprises obtaining the maximum size of the payload from a memory associated with the source node, wherein the maximum size of the payload is pre-configured in the memory.

In an embodiment, segmenting, by the source node, the data message into one or more segments comprises determining a count value of total segments required to be formed from the data message based on a size of the data message and the maximum size of the payload. Further, partitioning the data message into one or more segments equal to the count value of total segments, wherein a size of each of the one or more segments is lesser than or equal to the maximum size of the payload. Furthermore, appending a segmentation set identifier value to each of the one or more segments, wherein the segmentation set identifier value is a unique identifier associated with the one or more segments. Thereafter, appending a segment sequence number to each of the one or more segments, wherein the segment sequence number indicates a message number associated with each of the one or more segments. Subsequently, appending a destination identifier value to each of the one or more segments. In addition, appending the count value of total segments in a first segment from the one or more segments. Finally, setting a value of the last segment flag to “1” in the last segment from the one or more segments.

In an embodiment, detecting, by the destination node, whether a subset of segments from the one or more segments are missing upon receiving a last segment or upon completion of a pre-determined time duration comprises identifying a segment sequence number associated with the first segment and the last segment from the one or more segments. Further, determining a presence or an absence of the subset of segments not received from the source node. Furthermore, detecting that the subset of segments from the one or more segments are missing upon determining the absence of the subset of segments.

In an embodiment, performing, by the destination node, the recovery of the one or more missing segments comprises identifying a segment sequence number of the subset of segments missing in the one or more segments. Further, sending a segment recovery request message to the source node, wherein the segment recovery request message comprises a segmentation set identifier value of the data message, and a list of segment range associated with the subset of segments missing. Furthermore, receiving a segment recovery acknowledgement message form the source node in response to the segment recovery request message. Finally, receiving the subset of segments from the source node.

In an embodiment, receiving the subset of segments from the source node comprises awaiting for a segment in the subset of segments from the source node for a pre-defined time duration. Further, receiving the segment in the subset of segments from the source node within the pre-defined time duration. Alternatively, performing the recovery of the one or more missing segments in the subset of segments when the segment in the subset of segments is not received from the source node within the pre-defined time duration.

In an embodiment, performing, by the destination node, the re-assembly of the one or more segments comprises sorting the one or more segments based on at least one of a segment sequence number, a count value of total segments, and a value of the last segment flag. Further, combining a data payload in the one or more segments based on the sorting of the one or more segments to form the data message.

In an embodiment, the confirmation message comprises a segmentation set identifier value, and a result value, wherein the result value indicates one of the successful reception or the un-successful reception of the data message to the source node.

In an embodiment, the result value indicates the un-successful reception of the data message when the recovery of the one or more missing segments fails.

In an embodiment, the result value indicates the un-successful reception of the data message when the re-assembly of the one or more segments fails.

Accordingly, the embodiments herein provide a method for communicating messages between a source node and a destination node in an Internet of Things (IoT) network using a Fifth Generation (5G) Message (MSGin5G) Service. The method comprises receiving, by a MSGin5G server, a first set of one or more segments of a data message from a source node using the MSGin5G service. Further, detecting, by the MSGin5G server, whether a subset of segments from the first set of the one or more segments are missing. Furthermore, performing, by the MSGin5G server, at least one of a recovery of one or more missing segments in the first set of the one or more segments and a re-assembly of the first set of the one or more segments to form the data message. Thereafter, identifying, by the MSGin5G server, a maximum size of a payload supported by the destination node. Subsequently, segmenting, by the MSGin5G server, the data message into a second set of one or more segments based on the maximum size of the payload supported by the destination node. Finally, sending the second set of the one or more segments to the destination node using the MSGin5G service.

In an embodiment, the source node is a MSGin5G client of a IoT device-1 and the destination node is a MSGin5G client of a IoT device-2.

In an embodiment, receiving, by the MSGin5G server, the first set of the one or more segments comprises the one or more segments of the data message segmented by the source node based on the maximum size of the payload supported by the source node.

In an embodiment, detecting, by the MSGin5G server, whether a subset of segments from the first set of the one or more segments are missing upon receiving a last segment or upon completion of a pre-determined time duration comprises identifying a segment sequence number associated with the first segment and the last segment from the first set of the one or more segments. Further, determining a presence or an absence of the subset of segments not received from the source node. Furthermore, detecting that the subset of segments from the first set of the one or more segments are missing upon determining the absence of the subset of segments.

In an embodiment, performing, by the MSGin5G server, the recovery of the one or more missing segments comprises identifying a segment sequence number of the subset of segments missing in the first set of the one or more segments. Further, sending a segment recovery request message to the source node, wherein the segment recovery request message comprises a segmentation set identifier value of the data message, and a list of segment range associated with the subset of segments missing. Furthermore, receiving a segment recovery acknowledgement message form the source node in response to the segment recovery request message; and receiving the subset of segments from the source node.

In an embodiment, performing, by the MSGin5G server, the re-assembly of the first set of the one or more segments comprises sorting the one or more segments based on at least one of a segment sequence number, a count value of total segments, and a value of the last segment flag. Further, combining a data payload in the first set of the one or more segments based on the sorting of the first set of the one or more segments to form the data message.

In an embodiment, identifying, by the MSGin5G server, the maximum size of the payload supported by the destination node comprises sending a query message to the destination node, wherein the query message comprises a request for the maximum size of the payload supported by the destination node. Further, receiving a response message from the destination node, wherein the response message comprises a value of the maximum size of the payload supported by the destination node.

In an embodiment, segmenting, by the MSGin5G server, the data message into the second set of the one or more segments comprises determining a count value of total segments required to be formed from the data message based on a size of the data message and the maximum size of the payload supported by the destination node. Further, partitioning the data message into the second set of the one or more segments equal to the count value of total segments, wherein a size of each of the one or more segments is lesser than or equal to the maximum size of the payload. Further, appending a segmentation set identifier value to each of the second set of the one or more segments, wherein the segmentation set identifier value is a unique identifier associated with the one or more segments. Thereafter, appending a segment sequence number to each of the second set of the one or more segments, wherein the segment sequence number indicates a message number associated with each of the one or more segments. Subsequently, appending a destination identifier value to each of the one or more segments. In addition, appending the count value of total segments in a first segment from the second set of the one or more segments. Finally, setting a value of the last segment flag to “1” in the last segment from the second set of the one or more segments.

In an embodiment, the method comprises detecting, by the destination node, whether a subset of segments from the second set of the one or more segments are missing. Further, performing, by the destination node, at least one of a recovery of one or more missing segments in the second set of the one or more segments, and a re-assembly of the second set of the one or more segments to form the data message.

In an embodiment, the method comprises receiving, by the MSGin5G server, a confirmation message comprising a segmentation set identifier value, and a result value from the destination node using the MSGin5G service, wherein the result value indicates one of the successful reception or the un-successful reception of the data message to the source node. Further, sending, by the MSGin5G server, the confirmation message to the source node using the MSGin5G service.

In an embodiment, the result value indicates the un-successful reception of the data message when the recovery of the one or more missing segments fails.

In an embodiment, the result value indicates the un-successful reception of the data message when the re-assembly of the one or more segments fails.

Accordingly, the embodiments herein provide a node for communicating messages in an Internet of Things (IoT) network using a Fifth Generation (5G) Message (MSGin5G) Service. The node comprises a memory, a processor, a MSGin5G controller communicatively coupled to a memory and a processor. The MSGin5G controller is configured to receive a data message from a source application. Further, the MSGin5G controller is configured to identify a maximum size of a payload supported by a destination node. Furthermore, the MSGin5G controller is configured to segment the data message into one or more segments based on the maximum size of the payload, wherein the one or more segments are sent using the MSGin5G service. Upon receiving the one or more segments, the MSGin5G controller is configured to detect whether a subset of segments from the one or more segments are missing. Thereafter, the MSGin5G controller is configured to perform at least one of a recovery of one or more missing segments in the one or more segments, and a re-assembly of the one or more segments to form the data message, wherein the data message is provided to a destination application. Finally, the MSGin5G controller is configured to send a confirmation message indicating one of a successful reception or an un-successful reception of the data message using the MSGin5G service.

In an embodiment, the node comprises at least one of a source node and a destination node.

In an embodiment, the source node is a MSGin5G server when the source application is an application server and the destination node is a MSGin5G client of a IoT device-1 when the destination application is an application client.

In an embodiment, the source node is a MSGin5G client of a IoT device-1 when the source application is an application client and the destination node is a MSGin5G server when the destination application is an application server.

In an embodiment, the MSGin5G controller in configured to identify the maximum size of the payload comprises sending a query message to the destination node, wherein the query message comprises a request for the maximum size of the payload supported by the destination node. Further, receiving a response message from the destination node, wherein the response message comprises a value of the maximum size of the payload supported by the destination node.

In an embodiment, the MSGin5G controller in configured to identify the maximum size of the payload comprises obtaining the maximum size of the payload from a memory associated with the source node, wherein the maximum size of the payload is pre-configured in the memory.

In an embodiment, the MSGin5G controller in configured to segment the data message into one or more segments comprises determining a count value of total segments required to be formed from the data message based on a size of the data message and the maximum size of the payload. Further, partitioning the data message into one or more segments equal to the count value of total segments, wherein a size of each of the one or more segments is lesser than or equal to the maximum size of the payload. Furthermore, appending a segmentation set identifier value to each of the one or more segments, wherein the segmentation set identifier value is a unique identifier associated with the one or more segments. Thereafter, appending a segment sequence number to each of the one or more segments, wherein the segment sequence number indicates a message number associated with each of the one or more segments. Subsequently, appending a destination identifier value to each of the one or more segments. In addition, appending the count value of total segments in a first segment from the one or more segments. Finally, setting a value of the last segment flag to “1” in the last segment from the one or more segments.

In an embodiment, the MSGin5G controller in configured to detect whether a subset of segments from the one or more segments are missing upon receiving a last segment or upon completion of a pre-determined time duration comprises identifying a segment sequence number associated with the first segment and the last segment from the one or more segments. Further, determining a presence or an absence of the subset of segments not received from the source node. Furthermore, detecting that the subset of segments from the one or more segments are missing upon determining the absence of the subset of segments.

In an embodiment, the MSGin5G controller in configured to perform the recovery of the one or more missing segments comprises identifying a segment sequence number of the subset of segments missing in the one or more segments. Further, sending a segment recovery request message to the source node, wherein the segment recovery request message comprises a segmentation set identifier value of the data message, and a list of segment range associated with the subset of segments missing. Furthermore, receiving a segment recovery acknowledgement message form the source node in response to the segment recovery request message. Thereafter, receiving the subset of segments from the source node.

In an embodiment, the MSGin5G controller in configured to receive the subset of segments from the source node comprises awaiting for a segment in the subset of segments from the source node for a pre-defined time duration. Further, receiving the segment in the subset of segments from the source node within the pre-defined time duration. Alternatively, performing the recovery of the one or more missing segments in the subset of segments when the segment in the subset of segments is not received from the source node within the pre-defined time duration.

In an embodiment, the MSGin5G controller in configured to perform the re-assembly of the one or more segments comprises sorting the one or more segments based on at least one of a segment sequence number, a count value of total segments, and a value of the last segment flag. Further, combining a data payload in the one or more segments based on the sorting of the one or more segments to form the data message.

Accordingly, embodiments herein provide a MSGin5G server for communicating messages between a source node and a destination node in an Internet of Things (IoT) network using a Fifth Generation (5G) Message (MSGin5G) Service. The MSGin5G server comprises a memory, a processor, and a MSGin5G controller communicatively coupled to a memory and a processor. The MSGin5G controller is configured to receive, a first set of one or more segments of a data message from a source node using the MSGin5G service. Further, the MSGin5G controller is configured to detect whether a subset of segments from the first set of the one or more segments are missing. Furthermore, the MSGin5G controller is configured to perform at least one of a recovery of one or more missing segments in the first set of the one or more segments, and a re-assembly of the first set of the one or more segments to form the data message. Thereafter, the MSGin5G controller is configured to identify a maximum size of a payload supported by the destination node. Subsequently, the MSGin5G controller is configured to segment the data message into a second set of one or more segments based on the maximum size of the payload supported by the destination node. Finally, the MSGin5G controller is configured to send the second set of the one or more segments to the destination node using the MSGin5G service.

In an embodiment, the source node is a MSGin5G client of a IoT device-1 and the destination node is a MSGin5G client of a IoT device-2.

In an embodiment, the MSGin5G controller in configured to receive the first set of the one or more segments comprises the one or more segments of the data message segmented by the source node based on the maximum size of the payload supported by the source node.

In an embodiment, the MSGin5G controller in configured to detect whether a subset of segments from the first set of the one or more segments are missing upon receiving a last segment or upon completion of a pre-determined time duration comprises identifying a segment sequence number associated with the first segment and the last segment from the first set of the one or more segments. Further, determining a presence or an absence of the subset of segments not received from the source node. Furthermore, detecting that the subset of segments from the first set of the one or more segments are missing upon determining the absence of the subset of segments.

In an embodiment, the MSGin5G controller in configured to perform the recovery of the one or more missing segments comprises identifying a segment sequence number of the subset of segments missing in the first set of the one or more segments. Further, sending a segment recovery request message to the source node, wherein the segment recovery request message comprises a segmentation set identifier value of the data message, and a list of segment range associated with the subset of segments missing. Furthermore, receiving a segment recovery acknowledgement message form the source node in response to the segment recovery request message. Thereafter, receiving the subset of segments from the source node.

In an embodiment, the MSGin5G controller in configured to perform the re-assembly of the first set of the one or more segments comprises sorting the one or more segments based on at least one of a segment sequence number, a count value of total segments, and a value of the last segment flag. Further, combining a data payload in the first set of the one or more segments based on the sorting of the first set of the one or more segments to form the data message.

In an embodiment, the MSGin5G controller in configured to identify the maximum size of the payload supported by the destination node comprises sending a query message to the destination node, wherein the query message comprises a request for the maximum size of the payload supported by the destination node. Further, receiving a response message from the destination node, wherein the response message comprises a value of the maximum size of the payload supported by the destination node.

In an embodiment, the MSGin5G controller in configured to segment the data message into the second set of the one or more segments comprises determining a count value of total segments required to be formed from the data message based on a size of the data message and the maximum size of the payload supported by the destination node. Further, partitioning the data message into the second set of the one or more segments equal to the count value of total segments, wherein a size of each of the one or more segments is lesser than or equal to the maximum size of the payload. Furthermore, appending a segment sequence number to each of the second set of the one or more segments, wherein the segment sequence number indicates a message number associated with each of the one or more segments. Thereafter, appending a destination identifier value to each of the second set of the one or more segments. Subsequently, appending the count value of total segments in a first segment from the second set of the one or more segments. In addition, appending the count value of total segments in a first segment from the second set of the one or more segments. Finally, setting a value of the last segment flag to “1” in the last segment from the second set of the one or more segments.

In an embodiment, the MSGin5G controller in configured to detect whether a subset of segments from the second set of the one or more segments are missing. Further, perform at least one of a recovery of one or more missing segments in the second set of the one or more segments. Furthermore, a re-assembly of the second set of the one or more segments to form the data message.

In an embodiment, the MSGin5G controller in configured to receive a confirmation message comprising a segmentation set identifier value, and a result value from the destination node using the MSGin5G service, wherein the result value indicates one of the successful reception or the un-successful reception of the data message to the source node. Further, send the confirmation message to the source node using the MSGin5G service.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This method is illustrated in the accompanying drawings, throughout which like reference letters indicate corresponding parts in the various figures. The embodiments herein will be better understood from the following description with reference to the drawings, in which:

FIG. 1 shows an exemplary environment for communicating messages using a Fifth

Generation (5G) Message (MSGin5G) Service, according to embodiments as disclosed herein;

FIG. 2a shows a block diagram of an Internet of Things (IoT) device, according to embodiments as disclosed herein;

FIG. 2b shows a block diagram of a MSGin5G Server, according to embodiments as disclosed herein;

FIG. 3 illustrates a flowchart showing a method steps for communicating messages between a source node and a destination node in an Internet of Things (IoT) network using a Fifth Generation (5G) Message (MSGin5G) Service, according to embodiments as disclosed herein;

FIG. 4 illustrates an exemplary communication of messages with segmentation and reassembly from an application server to an IoT device using MSGin5G service, according to the embodiments as disclosed herein;

FIG. 5 illustrates an exemplary communication of messages with segmentation and reassembly from an IoT device to an application server using MSGin5G service, according to the embodiments as disclosed herein;

FIG. 6 illustrates a recovery of one or more missing segments, according to the embodiments as disclosed herein;

FIG. 7 illustrates a flowchart showing method steps for communicating messages between a source node and a destination node via a MSGin5G server in an Internet of Things (IoT) network using a Fifth Generation (5G) Message (MSGin5G) Service, according to the embodiments as disclosed herein; and

FIG. 8 illustrates an exemplary communication of messages with segmentation and reassembly from an IoT device-1 to an IoT device-2 using MSGin5G service, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

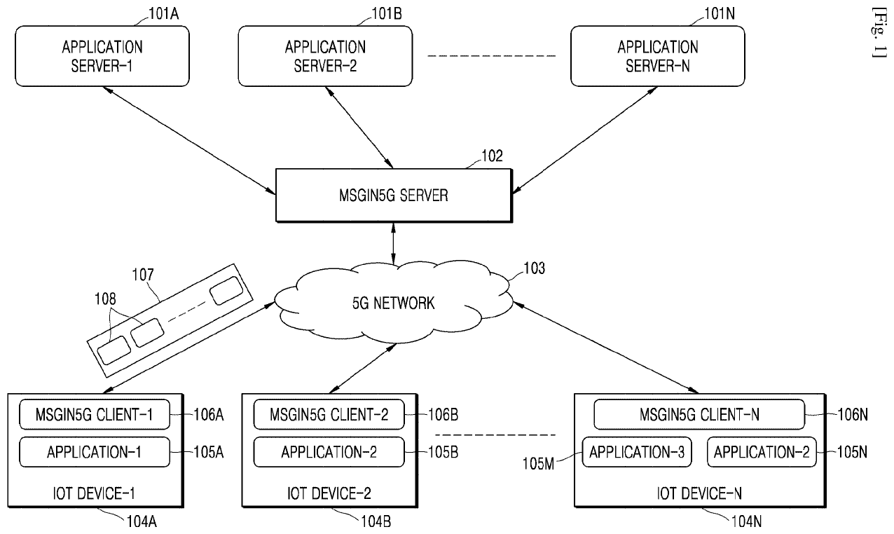

FIG. 1 shows an exemplary environment for communicating messages using a Fifth Generation (5G) Message (MSGin5G) Service, according to embodiments as disclosed herein.

In one implementation, an Internet of Things (IoT) network may include one or more IoT devices (104A, 104B, . . . , 104N) connected via a Fifth Generation (5G) network (103). The one or more IoT devices (104A, 104B, . . . , 104N) may include at least one of a sensor, a smartphone, a mobile, a laptop, a computer, a medical device, an automobile, and the like. The IoT network may include at least one of a wireless sensor network, a vehicular network, a mesh network, and the like. The one or more IoT devices (104A, 104B, . . . , 104N) may send and receive communication messages (107) using a MSGin5G service via the MSGin5G server (102). The MSGin5G server (102) is an entity in the 5G system for routing the communication messages (107) between the IoT devices (104A, 104B, . . . , 104N) and messages between the one or more application servers (101A, 101B, . . . , 101N) and the IoT devices (104A, 104B, . . . , 104N). Further, the MSGin5G Service is a Mobile Network Operator (MNO) message service within the 5G System. The MSGin5G service enables a point-to-point, application-to-point, a group and broadcast message delivery.

In an embodiment, the application-to-point indicates the communication message originated at the one or more application servers (101A, 101B, . . . , 101N) in the IoT network and terminated at the one or more IoT devices (104A, 104B, . . . , 104N). Alternatively, the point-to-application indicates the communication message originated at the one or more IoT devices (104A, 104B, . . . , 104N) in the IoT network and terminated at the one or more application servers (101A, 101B, . . . , 101N). The point-to-point indicates the communication message originated at the one or more IoT devices (104A, 104B, . . . , 104N) in the IoT network and terminated at the one or more IoT devices (104A, 104B, . . . , 104N). Further, the one or more IoT devices (104A, 104B, . . . , 104N) comprises one or more applications (105A, 105B, . . . , 105N) for generating the communication messages (107) and/or processing the received communication messages (107). The communication messages (107) generated by the one or more applications (105A, 105B, . . . , 105N) is provided to a MSGin5G client (106A, 106B, . . . , 106N) in the one or more IoT devices (104A, 104B, . . . , 104N) for segmenting and sending the communication message using the MSGin5G service. In another embodiment, the MSGin5G client (106A, 106B, . . . , 106N) in the one or more IoT devices (104A, 104B, . . . , 104N) may receive the communication messages (107) using the MSGin5G service, perform recovery of one or more missing segments and a re-assembly of the one or more segments (108) to form the communication message. Further, the MSGin5G client (106A, 106B, . . . , 106N) in the one or more IoT devices (104A, 104B, . . . , 104N) provides the communication messages (107) to the corresponding one or more applications (105A, 105B, . . . , 105N).

A source node indicates the MSGin5G client (106A, 106B, . . . , 106N) of the one or more IoT devices (104A, 104B, . . . , 104N) when the source application is an application client (i.e. one or more applications (105A, 105B, . . . , 105N)) where the communication message originates. In another embodiment, the source node indicates the MSGin5G server (102) when the source application is the one or more application servers (101A, 101B, . . . , 101N) where the communication message originates. Further, a destination node indicates the MSGin5G client (106A, 106B, . . . , 106N) of the one or more IoT devices (104A, 104B, . . . , 104N) where the communication message terminates when the destination application is the application client (i.e. one or more applications (105A, 105B, . . . , 105N)) and when the source node is the MSGin5G server (102). In another embodiment, the destination node indicates the MSGin5G server (102) where the communication message terminates when the destination application is the one or more application servers (101A, 101B, . . . , 101N) and when the source application is the one or more applications (105A, 105B, . . . , 105N) in the one or more IoT devices (104A, 104B, . . . , 104N).

In an embodiment, an MSGin5G Gateway (not shown in figures) is an entity in the 5G system for interworking the communication messages (107) between the one or more IoT devices (104A, 104B, . . . , 104N) using the MSGin5G Service and the one or more IoT devices (104A, 104B, . . . , 104N) using a non-3GPP message service (for example, a Wireless Local Area Network). For example, an application-1 (105A) in an IoT device-1 (104A) may communicate messages with an application server (101A) or with an application-3 (105M) in an IoT device-N (104N).

In an embodiment, the communication message (i.e. data message (107)) in MSGin5G Service may use different transport networks and access networks. The terms “communication message” and “data message (107)” may be used interchangeably in the document herein. In one embodiment, the source node may require to transmit the data message (107) of size larger than a maximum size of a payload (or packet) supported by the access network of the destination node and the transport network using by the destination node. The 3GPP provides different values of the maximum size of the payload for different transport networks. Further, the MSGin5G Service is required to support variable size of the data message (107) upto a maximum of 2048 bytes. Further, the MSGin5G service is required to support transmission of the segmented messages when the size of the data message (107) is larger than the maximum size of the payload.

Furthermore, the access network does not provide a support for the segmentation and reassembly of the data message (107) as it increases the overhead in the 5G network. Therefore, the source node using the MSGin5G service applications with a variety of transport networks (for example, NIDD, SMS, and the like.), supports the segmentation and reassembly of the data message (107) when the size of the data message (107) exceeds the maximum size of the payload supported by the destination node.

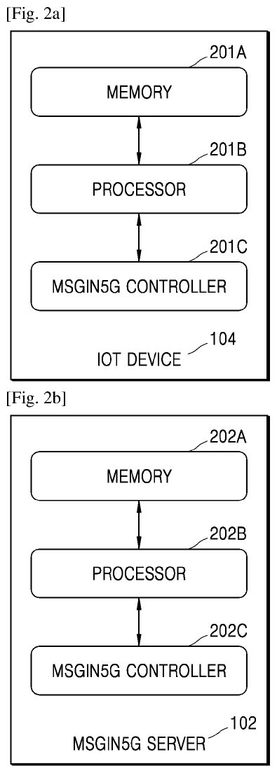

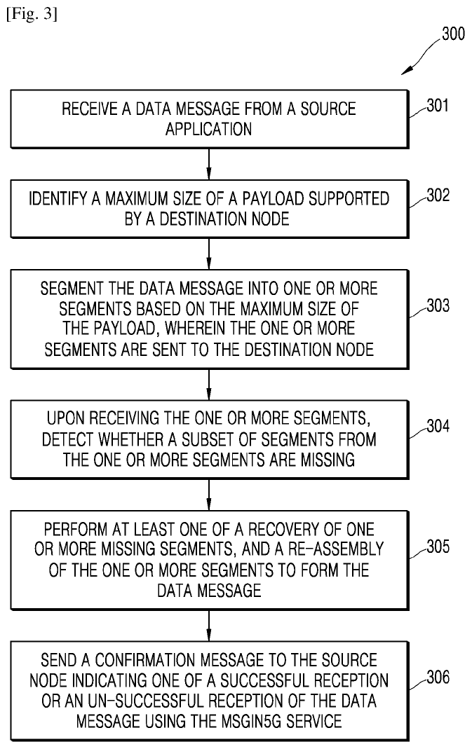

FIG. 2 shows a block diagram of the Internet of Things (IoT) device (104) and the

MSGin5G server (102), according to embodiments as disclosed herein.

In one implementation, the IoT device (104) as shown in FIG. 2A may include a memory (201A), a processor (201B), and a MSGin5G controller (201C) communicatively coupled to the memory (201A) and the processor (201B). The IoT device (104) may be the source node and/or the destination node. The MSGin5G controller (201C) in the source node is configured to receive a data message (107) from a source application. Further, the MSGin5G controller (201C) in the source node is configured to identify a maximum size of a payload supported by a destination node. Furthermore, the MSGin5G controller (201C) in the source node is configured to segment the data message (107) into one or more segments (108) based on the maximum size of the payload supported by the destination node. The MSGin5G controller (201C) in the source node is configured to send the one or more segments (108) to the destination node using the MSGin5G service.

In an embodiment, upon receiving the one or more segments (108), the MSGin5G controller (201C) in the destination node is configured to detect whether a subset of segments from the one or more segments (108) are missing. Further, the MSGin5G controller (201C) in the destination node is configured to perform at least one of a recovery of one or more missing segments in the one or more segments (108), and a re-assembly of the one or more segments (108) to form the data message (107). Further, the MSGin5G controller (201C) in the destination node is configured to provide the data message (107) to a destination application. Furthermore, the MSGin5G controller (201C) in the destination node is configured to send a confirmation message indicating one of a successful reception or an un-successful reception of the data message (107) to the source node using the MSGin5G service.

In one implementation, the MSGin5G server (102) as shown in FIG. 2B may include a memory (202A), a processor (202B), and a MSGin5G controller (202C) communicatively coupled to the memory (202A) and the processor (202B). The MSGin5G server (102) is an entity for routing the data messages (107) from the source node and to the destination node. The MSGin5G controller (202C) is configured to receive a first set of one or more segments (108) of the data message (107) from the source node using the MSGin5G service. Further, the MSGin5G controller (202C) is configured to detect whether a subset of segments from the first set of the one or more segments (108) are missing. Furthermore, the MSGin5G controller (202C) is configured to perform at least one of a recovery of one or more missing segments in the first set of the one or more segments (108), and a re-assembly of the first set of the one or more segments (108) to form the data message (107).

In an embodiment, the MSGin5G controller (202C) is configured to identify a maximum size of a payload supported by the destination node. Further, the MSGin5G controller (202C) is configured to segment the data message (107) received from the first node into a second set of one or more segments (108) based on the maximum size of the payload supported by the destination node. Furthermore, the MSGin5G controller (202C) is configured to send the second set of the one or more segments (108) to the destination node using the MSGin5G service.

FIG. 3 illustrates a flowchart showing a method steps for communicating messages between a source node and a destination node in an Internet of Things (IoT) network using a Fifth Generation (5G) Message (MSGin5G) Service, according to embodiments as disclosed herein.

At the step 301, the method comprises receiving, by a source node, the data message (107) from the source application.

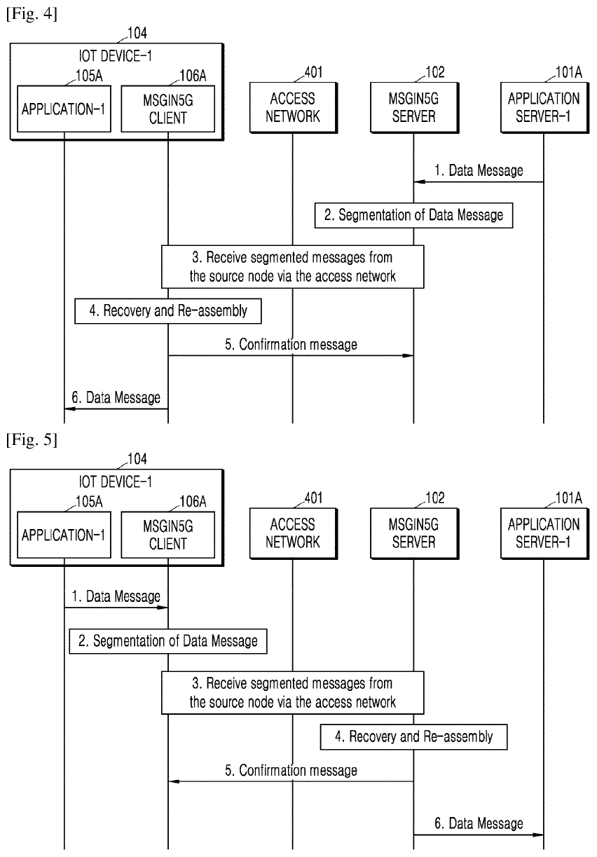

In an embodiment, the source node is the MSGin5G server (102) when the source application is the one or more application servers (101A, 101B, . . . , 101N) and the destination node is the MSGin5G client (106A, 106B, . . . , 106N) of the one or more IoT devices (104A, 104B, . . . , 104N) when the destination application is the application client (i.e. the one or more applications (105A, 105B, . . . , 105N)). For example, the application server (101A) is the source application generating the data message (107) with a large payload, and the source node is the MSGin5G server (102) as shown in FIG. 4. Further, the destination node is the MSGin5G client (106A) of the IoT device-1 (104A) and the destination application is the application client (i.e. application-1 (105A)) as shown in FIG. 4.

In another embodiment, the source node is the MSGin5G client (106A, 106B, . . . , 106N) of the one or more IoT devices (104A, 104B, . . . , 104N) when the source application is the application client (i.e. the one or more applications (105A, 105B, . . . , 105N)) and the destination node is a MSGin5G server (102) when the destination application is the one or more application servers (101A, 101B, . . . , 101N). For example, the MSGin5G client (106A) of the IoT device-1 (104A) is the source node and the application client (i.e. application-1 (105A)) is the source application generating the data message (107) with a large payload as shown in FIG. 5. Further, the destination node is the MSGin5G server (102) and the destination application is the application server (101A) as shown in FIG. 5.

In an embodiment, the MSGin5G Client (106A) of the IoT device-1 (104A) registers with the MSGin5G server (102) using the MSGin5G service before sending and receiving the data messages (107). In a first embodiment, the MSGin5G server (102) receives the data message (107) from the application server-1 (101A) as shown in signal 1 of the FIG. 4. The data message (107) is to be delivered to the destination node i.e. MSGin5G client (106A) of the IoT device-1 (104A). In a second embodiment, the MSGin5G client (106A) receives the data message (107) from the application-1 (101A) as shown in signal 1 of the FIG. 5. The data message (107) is to be delivered to the destination node i.e. MSGin5G server (102).

At the step 302, the method comprises identifying, by the source node, the maximum size of the payload supported by the destination node.

In an embodiment, identifying, by the source node, the maximum size of the payload comprises sending a query message to the destination node. Where the query message comprises a request for the maximum size of the payload supported by the destination node. The maximum size of the payload is determined based on the access network (401) and the transport network associated with the destination node. In response to the query message, the destination node sends a response message with the maximum size of the payload. The source node receives the response message from the destination node. The response message comprises a value of the maximum size of the payload supported by the destination node.

In another embodiment, identifying, by the source node, the maximum size of the payload comprises obtaining the maximum size of the payload from a memory associated with the source node. Where the maximum size of the payload is preconfigured in the memory.

At the step 303, the method comprises segmenting, by the source node, the data message (107) into one or more segments (108) based on the maximum size of the payload, wherein the one or more segments (108) are sent to the destination node using the MSGin5G service.

In an embodiment segmenting, by the source node, the data message (107) into one or more segments (108) comprises determining a count value of total segments required to be formed from the data message (107) based on a size of the data message (107) and the maximum size of the payload. For example, if the size of the data message (107) is 460 bytes and the maximum size of the payload is 100 bytes, then the count value of total segments is determined as 5 by dividing the size of the data message (107) by the maximum size of the payload. In another example, if the size of the data message (107) is 50 bytes and the maximum size of the payload is 100 bytes, then the count value of total segments is determined as 1 (i.e. the entire data message (107) is sent as the one segment)

In an embodiment, the source node partitions the data message (107) into one or more segments (108) equal to the count value of total segments. Where a size of each of the one or more segments (108) is lesser than or equal to the maximum size of the payload. For example, if the maximum size of the payload is 100 bytes, then the size of the each of the one or more segments (108) is less than or equal to 100 bytes.

In an embodiment, the source node appends a segmentation set identifier value to each of the one or more segments (108), wherein the segmentation set identifier value is a unique identifier associated with the one or more segments (108). The segmentation set identifier value uniquely identifies the one or more segments (108) associated with different data messages (107). Further, the source node appends a segment sequence number to each of the one or more segments (108), wherein the segment sequence number indicates a message number associated with each of the one or more segments (108). The sequence number uniquely identifies the segment within the one or more segments (108). Furthermore, the source node appends a destination identifier value to each of the one or more segments (108). The destination identifier value is associated with the destination node for which the one or more segments (108) is to be delivered.

In an embodiment, the source node appends the count value of total segments in a first segment from the one or more segments (108). The count value of total segments indicates the number of segments formed from the data message (107). Further, the source node sets a value of the last segment flag to “1” in the last segment from the one or more segments (108).

For example, the below table-1 indicates the one or more information elements appended in the one or more segments (108) of the data message (107) at the source node.

TABLE 1

| Information element | Status | Description |
|---|---|---|
| Segmentation Set | M | One or more segments (108) |
| Identifier | | associated with the data |
| | | message (107) are assigned |
| | | the same unique identifier |
| | | value. |
| Segment Sequence | M | An incrementing counter that |
| Number | | indicates the sequence |
| | | number of each segmented |
| | | message within one or more |
| | | segments (108). |
| Last Segment Flag | O | An indicator of the last |
| | | segment from the one or more |
| | | segments (108) of the data |
| | | message (107). |
| Total Segments | O | An integer indicating total |
| | | number of segments |
| | | associated with the |
| | | Segmentation Set Identifier. |
| Destination identifier | M | An identifier value of the |
| | | destination node. |

M denotes it is a mandatory field in each of the one or more segments (108). O denotes it is an optional field in each of the one or more segments (108).
The Last Segment Flag needs to be including only in the last segment from the one or more segments (108) of the data message (107).
The Total Segments needs to be included only in the first segment from the one or more segments (108) of the data message (107).

Each of the one or more segments (108) is sent as an individual access network (401) transport packet to the destination node using the MSGin5G service via the 5G network (103). For example, the data message (107) segmented into one or more segments (108) by the MSGin5G server (102) (i.e. source node) is denoted by the signal 2 of FIG. 4. Further, the one or more segments (108) of the data message (107) is sent to the destination node (i.e. the MSGin5G client (106A) of the IoT device-1 (104A) via the access network (401) using the MSGin5G service is denoted by signal 3 of FIG. 4. In another example, the data message (107) segmented into one or more segments (108) by the MSGin5G client (106A) of the IoT device-1 (104A) is denoted by the signal 2 of FIG. 5. Further, the one or more segments (108) of the data message (107) is sent to the destination node (i.e. MSGin5G server (102)) via the access network (401) using the MSGin5G service is denoted by signal 3 of FIG. 5.

At the step 304, upon receiving the one or more segments (108) from the source node, the method comprises detecting, by the destination node, whether a subset of segments from the one or more segments (108) are missing.

In an embodiment, upon receiving each of the one or more segments (108), the destination node checks if the last Segment Flag is set to one “1” If the segment with the last segment flag set to one “1” is received, the destination node performs detecting whether a subset of segments from the one or more segments (108) are missing. Alternatively, if a pre-determined time duration has elapsed after receiving a segment form the one or more segments (108), the destination node performs detecting whether a subset of segments from the one or more segments (108) are missing. For example, the pre-determined time duration may be 20 milliseconds, 1 second and the like. The pre-determined time duration is configured in the destination.

In an embodiment, detecting, by the destination node, whether a subset of segments from the one or more segments (108) are missing comprises identifying the segment sequence number associated with the first segment and the last segment from the one or more segments (108). For example, the destination node may identify the segment sequence number of the first segment is 21 and the segment sequence number of the second segment is 35. Further, determining a presence or an absence of the subset of segments not received from the source node based on the segment sequence number of the first segment and the last segment. For example, the destination node determines if the segments with the segment sequence number between 21 and 35 are present (i.e. received) or if any segment between the segment sequence number 21 and 35 are absent (i.e. not received). Furthermore, detecting that the subset of segments from the one or more segments (108) are missing upon determining the absence of the subset of segments. For example, if segments with segment sequence number say 26 and 29 are absent, then the destination node detects that the subset of segments with segment sequence number 26 and 29 are missing. The subset of segments missing from the one or more segments (108) are denoted as one or more missing segments.

At the step 305, the method comprises performing, by the destination node, at least one of a recovery of one or more missing segments in the one or more segments (108) and a re-assembly of the one or more segments (108) to form the data message (107), wherein the data message (107) is provided to a destination application.

In an embodiment, the destination node performs the recovery of the one or more missing segments. If the one or more missing segments are absent (i.e. if one or more segments (108) of the data message (107) are received), then the destination node performs the re-assembly of the one or more segments (108) to form the data message (107). For example, the destination node (i.e. MSGin5G client (106A) of the IoT device-1 (104A) performing the recovery and re-assembly is denoted by the signal 4 in FIG. 4. In another example, the destination node (i.e. MSGin5G server (102) performing the recovery and re-assembly is denoted by the signal 4 in FIG. 5.

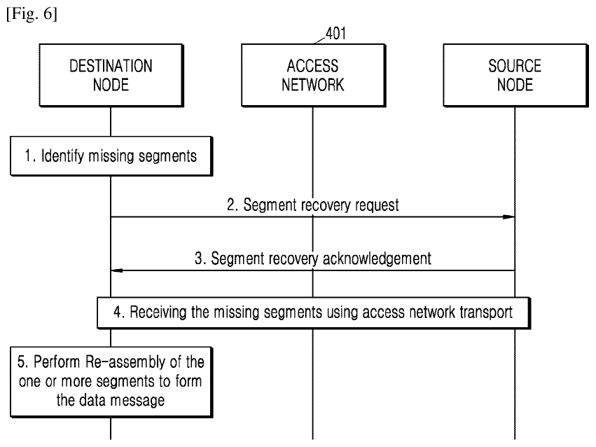

In an embodiment, performing, by the destination node, the recovery of the one or more missing segments comprises identifying a segment sequence number of the subset of segments missing in the one or more segments (108) denoted by the signal 1 in FIG. 6. The one or more missing segments is identified based on the segment sequence number associated with the first segment and the value of the total segments in the first segment. For example, if the segment sequence number associated with the first segment is 1 and the value of the total segments in the first segment is 27, then the destination node identifies the one or more missing segments by checking the segment sequence number associated with each of the one or more segments (108) having the same segmentation set identifier value.

Further, the destination node sends a segment recovery request message to the source node denoted by the signal 2 in FIG. 6. The segment recovery request message comprises a segmentation set identifier value of the data message (107), and a list of segment range associated with the subset of segments missing. The Table-2 shows the one or more information elements of the segment recovery request message.

TABLE 2

| Information element | Status | Description |
|---|---|---|
| Segmentation Set | M | The Segmentation Set Identifier as |
| Identifier | | received in one or more segments |
| | | (108). |
| List of Segment range | M | List of Segment range which the |
| | | client wants to recover, each |
| | | segment range consist of start and |
| | | end sequence number of missing |
| | | segments for example (5-7, 10-10, |
| | | 15-19). |

Furthermore, the destination node receives a segment recovery acknowledgement message form the source node in response to the segment recovery request message denoted by the signal 3 in FIG. 6. The segment recovery acknowledgement message indicates the reception of the request for the one or more missing segments by the source node. Thereafter, the destination node receives the subset of segments missing from the source node denoted by the signal 4 in FIG. 6.

In an embodiment, receiving, by the destination node, the subset of segments from the source node comprises awaiting for a segment in the subset of segments from the source node for a pre-defined time duration. The pre-determined time duration is configured in the destination. Further, receiving the segment in the subset of segments from the source node within the pre-defined time duration. If the segment in the subset of segments is received from the source node within the pre-defined time duration, the destination node awaits for a subsequent segment in the subset of segments from the source node for the pre-defined time duration.

If the segment in the subset of segments is not received from the source node within the pre-defined time duration, the destination node performs the recovery of the one or more missing segments in the subset of segments. The recovery of the one or more missing segments denoted by the FIG. 6 may be performed by the destination node until the reception of the subset of the segments missing from the one or more segments (108).

In an embodiment, the destination node performs the re-assembly of the one or more segments (108) after the recovery of the one or more missing segments denoted by signal 5 in the FIG. 6 and signal 4 in FIG. 4 and signal 4 in FIG. 5.

In an embodiment, performing, by the destination node, the re-assembly of the one or more segments (108) comprises sorting the one or more segments (108) based on at least one of a segment sequence number, a count value of total segments, and a value of the last segment flag. The one or more segments (108) are sorted in an ascending order starting from the first segment to the last segment using the segment sequence number associated with each of the one or more segments (108). The first segment is identified by the presence of the count value of total segments, and last segment is identified by the presence of a value equal to one “1” in the last segment flag.

In an embodiment, the destination node combines a data payload in the one or more segments (108) based on the sorting of the one or more segments (108) to form the data message (107). The data payload indicates the information in each of the one or more segments (108) excluding the one or more information elements of the Table-1 appended by the source node during segmentation.

At the step 306, the method comprises sending, by the destination node, the confirmation message to the source node indicating one of a successful reception or an un-successful reception of the data message (107) using the MSGin5G service, depending on the application requirement.

In an embodiment, the confirmation message comprises a segmentation set identifier value, and a result value, wherein the result value indicates one of the successful reception or the un-successful reception of the data message (107) to the source node. The Table-3 provides the one or more information elements of the confirmation message sent by the destination node.

TABLE 3

| Information element | Status | Description |
|---|---|---|
| Segmentation Set | M | The Segmentation Set |
| Identifier | | Identifier as received in |
| | | segments. |
| Result | M | Indicates the “success” or |
| | | “failure” |

In an embodiment, the result value indicates the un-successful reception (i.e. Failure) of the data message (107) when the recovery of the one or more missing segments fails. Alternatively, the result value indicates the un-successful reception of the data message (107) when the re-assembly of the one or more segments (108) fails due to an error in data payload of the one or more segments (108).

For example, the destination node sending the confirmation message to the source node is denoted by the signal 5 in FIG. 4 and signal 5 of FIG. 5. Further, the destination node provides the data message (107) to the destination application denoted by the signal 6 in FIG. 4 and signal 6 of FIG. 5.

In an embodiment, referring to FIG. 4, an Application Server (101A) sends a data message (107) with a large payload to the MSGin5G Server (102) that targets an Application Client (i.e. MSGin5G Client (106A)) on a UE (i.e. IoT Device (104)) and that has a size that exceeds the maximum allowed packet size of the access network transport supported by the targeted UE. Further, the MSGin5G Server (102) compares the size of the received message to the maximum allowed packet size of the access network transport of the targeted UE and detects that the size exceeds the limit. As a result, the MSGin5G Sever (102) segments the received message into a set of segmented messages such that each segmented message can fit within an individual access network transport packet. Within segmented message, the information elements defined in Table (1) are included to enable the MSGin5G Client (106A) on the targeted UE to reassemble the segmented messages. The destination identifier contains target UE identity. The MSGin5G Server (102) sends each segmented message to the targeted UE within an individual access network transport packet. The target UE checks for the Last Segment Flag in each of the received segment before proceeding to Step 4 of FIG. 4. If the next segment is not received within the expected time (based on configuration) then proceed to step 4 of FIG. 4. If MSGin5G Client (106A) has received segment with Last Segment Flag indication in it, the MSGin5G Client (106A) reassembles all segments into a single data message (107) based on the information elements defined in Table (1). If any segment(s) is (are) not received before last segment or no segments received within expected time, then the MSGin5G Client (106A) acts as Message receiver and recovers the segments as described in FIG. 6, before continuing with rest of the steps. The MSGin5G Client (106A) sends Message status request (i.e. confirmation message) to the MSGin5G server (102). The information elements defined in Table (3) are included in the request. The result information element will contain “success” if the reassembly of the segments is success. Otherwise, the result information element will contain “failure”. The MSGin5G server (102) may send acknowledge back to MSGin5G Client (106A) based on application requirement. If reassembly of segments is success, the MSGin5G Client (106A) delivers the contents of the data message (107) to the targeted Application Client (i.e. Application-1 (105A)). If MSGin5G client (106A) has not received all messages (even after recovery procedure) or reassembly of segments failed for any reason (e.g. corrupt data) then the MSGin5G client (106A) will notify receiving of failed message to application client.

In an embodiment, referring to FIG. 5, an Application Client (i.e. Application-1 (105A) on a UE (i.e. IoT device (104) sends a data message (107) with a large payload to a MSGin5G Client (106A) that targets an Application Server (101A) and that has a size that exceeds the maximum allowed packet size of the access network transport supported by the UE. The MSGin5G Client (106A) compares the size of the received data message (107) to the maximum allowed packet size of the access network transport supported by the UE and detects that the size exceeds the limit. As a result, the MSGin5G Client (106A) segments the received data message (107) into a set of segmented messages (i.e. one or more segments (108)) such that each segmented message can fit within an individual access network transport packet. Within each segmented message, the information elements defined in Table (1) are included to enable the MSGin5G Server to reassemble the segmented messages. The destination identifier contains application server identity. Further, the MSGin5G Client (106A) sends each segmented message to the MSGin5G Server (102) within an individual access network transport packet. The MSGin5G server (102) checks for the Last Segment Flag in each of the received segment before proceeding to Step 4 of FIG. 5. If the next segment is not received within the expected time (based on configuration) then proceed to step 4 of FIG. 5. If MSGin5G server (102) has received segment with Last Segment Flag indication in it, the MSGin5G Server (102) reassembles all segments into a single MSGin5G message based on the information elements defined in Table (1). If any segment(s) is (are) not received before last segment or no segments received within expected time, then the MSGin5G server (102) acts as a Message receiver and recovers the segments as described in FIG. 6, before continuing with rest of the steps. The MSGin5G Server (102) sends Message status request (i.e. confirmation message) to the MSGin5G client (106A). The information elements defined in Table (3) are included in the request. The result information element will contain “success” if the reassembly of the segments is success. Otherwise, the result information element will contain “failure”. Furthermore, the MSGin5G client (106A) may send acknowledge back to MSGin5G server (102) based on application requirement. If reassembly of segments is success, the MSGin5G Server (102) delivers the contents of the data message (107) to the targeted Application Server. If MSGin5G server (102) has not received all messages (even after recovery procedure) or re-assembly of segments failed for any reason (e.g. corrupt data) then the MSGin5G server (102) will notify receiving of failed message to application server.

In an embodiment, referring to FIG. 6, the Message Receiver detects that few segments are missing to reassemble complete data message (107). The Message receiver sends the segment recovery request to Message sender. The information elements defined in Table (2) are included in the segment recovery request message. The Message sender sends Segment recovery acknowledgement to the Message receiver. The Message sender sends each segmented message to the Message receiver within an individual access network transport packet. If the next segment is not received within the expected time (based on configuration) then the Message receiver may consider as recovery failed or may initiate the procedure again with updated list of segment range. The segment recovery procedure may repeat based on the configuration.

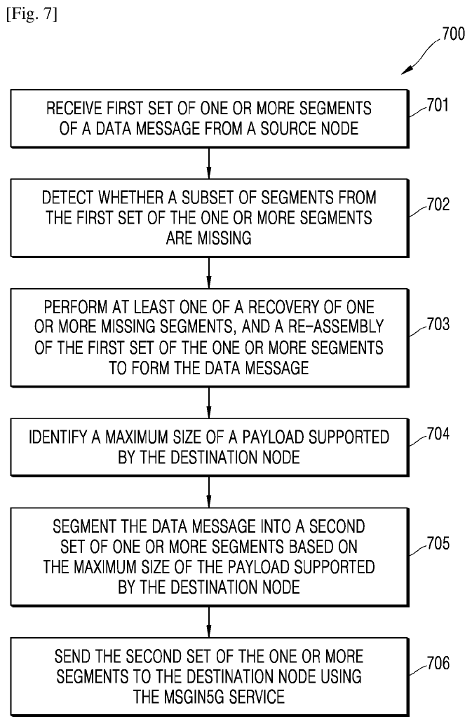

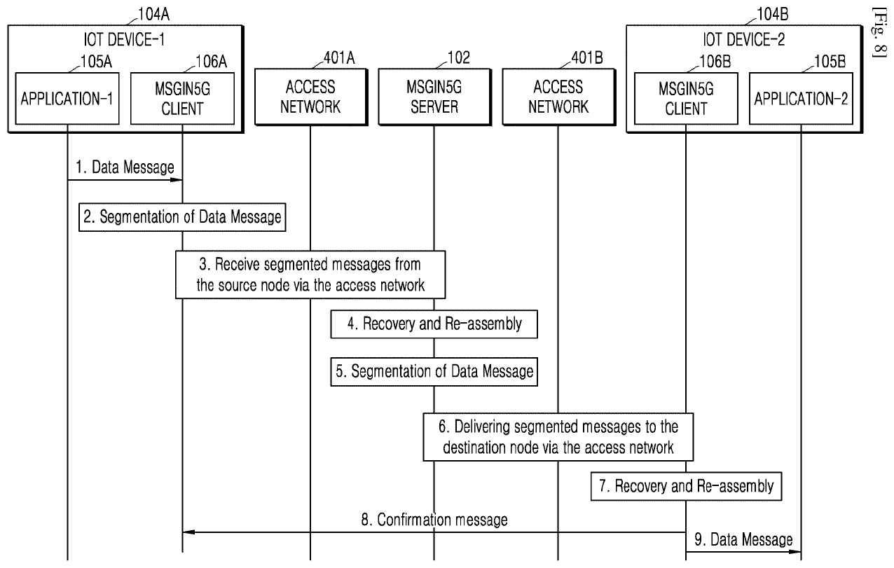

FIG. 7 illustrates a flowchart showing method steps for communicating messages between a source node and a destination node via a MSGin5G server (102) in an Internet of Things (IoT) network using a Fifth Generation (5G) Message (MSGin5G) Service, according to the embodiments as disclosed herein.

At the step 701, the method comprises receiving, by the MSGin5G server (102), a first set of one or more segments (108) of the data message (107) from the source node using the MSGin5G service.

In an embodiment, the source node is the MSGin5G client (106A) of the IoT device-1 (104A) and the destination node is the MSGin5G client (106B) of the IoT device-2 (104B). The source node sends the data message (107) to the destination node via the MSGin5G server (102) using the MSGin5G service.

In an embodiment, receiving, by the MSGin5G server (102), the first set of the one or more segments (108) comprises the one or more segments (108) of the data message (107) segmented by the source node based on the maximum size of the payload supported by the source node. The data message (107) with a large payload is generated by the source application (i.e. Application-1 (105A) in the IoT device-1 (104A)) and provided to the source node in the IoT device-1 (104A) as denoted by the signal 1 in FIG. 8. Further, the source node segments the data message (107) into first set of the one or more segments (108) based on the maximum size of the payload supported by the source node. The maximum size of the payload is configured in the memory of the IoT device-1 (101A). Further, segmentation of the data message (107) into first set of the one or more segments (108) is performed as detailed in the step 303 of FIG. 3. Furthermore, the MSGin5G server (102) receives the first set of the one or more segments (108) from the source node as denoted by the signal 3 in FIG. 8.

At the step 702, the method comprises detecting, by the MSGin5G server (102), whether a subset of segments from the first set of the one or more segments (108) are missing.

Upon receiving the last segment from the first set of one or more segments (108), the MSGin5G server (102) detects whether a subset of segments from the first set of the one or more segments (108) are missing. In another embodiment, upon completion of the pre-determined time duration, the MSGin5G server (102) detects whether a subset of segments from the first set of the one or more segments (108) are missing. The pre-determined time duration is configured in the MSGin5G server (102).

In an embodiment, detecting, by the MSGin5G server (102), whether a subset of segments from the first set of the one or more segments (108) are missing comprises identifying a segment sequence number associated with the first segment and the last segment from the first set of the one or more segments (108). Further, determining a presence or an absence of the subset of segments not received from the source node. Furthermore, detecting that the subset of segments from the first set of the one or more segments (108) are missing upon determining the absence of the subset of segments. The subset of segments from the first set of the one or more segments (108) missing is denoted as the first set of one or more missing segments. The detection of the one or more missing segments in the first set of one or more segments (108) is performed by the MSGin5G server (102) as detailed in the step 304 of the FIG. 3.

At the step 703, the method comprises performing, by the MSGin5G server (102), at least one of the recovery of one or more missing segments in the first set of the one or more segments (108), and the re-assembly of the first set of the one or more segments (108) to form the data message (107) denoted by the signal 4 in the FIG. 8.

In an embodiment, performing, by the MSGin5G server (102), the recovery of the one or more missing segments comprises identifying a segment sequence number of the subset of segments missing in the first set of the one or more segments (108). Further, sending a segment recovery request message to the source node, wherein the segment recovery request message comprises a segmentation set identifier value of the data message (107), and a list of segment range associated with the subset of segments missing. Furthermore, receiving a segment recovery acknowledgement message form the source node in response to the segment recovery request message. Thereafter, receiving the subset of segments from the source node. The MSGin5G server (102) performs the recovery of the one or more missing segments from the first set of one or more segments (108) as detailed in the step 305 of FIG. 3 using the signals 1 to 4 as detailed in FIG. 6.

After performing the recovery of the one or more missing segments, the MSGin5G server (102) performs the re-assembly of the first set of the one or more segments (108) denoted by the signal 4 in FIG. 8. In an embodiment, performing, by the MSGin5G server (102), the re-assembly of the first set of the one or more segments (108) comprises sorting the one or more segments (108) based on at least one of a segment sequence number, a count value of total segments, and a value of the last segment flag. Further, combining a data payload in the first set of the one or more segments (108) based on the sorting of the first set of the one or more segments (108) to form the data message (107). The MSGin5G server (102) performs the re-assembly of the first set of the one or more segments (108) as detailed in the step 305 of the FIG. 3.

At the step 704, the method comprises identifying, by the MSGin5G server (102), the maximum size of the payload supported by the destination node.

In an embodiment, identifying, by the MSGin5G server (102), the maximum size of the payload supported by the destination node comprises sending a query message to the destination node, wherein the query message comprises a request for the maximum size of the payload supported by the destination node. Further, receiving a response message from the destination node, wherein the response message comprises a value of the maximum size of the payload supported by the destination node.

In another embodiment, identifying, by the MSGin5G server (102), the maximum size of the payload comprises obtaining the maximum size of the payload from a memory associated with the source node, wherein the maximum size of the payload is pre-configured in the memory. The MSGin5G server (102) identifying the maximum size of the payload is performed as detailed in step 302 of FIG. 3.

At the step 705, the method comprises segmenting, by the MSGin5G server (102), the data message (107) into a second set of one or more segments (108) based on the maximum size of the payload supported by the destination node denoted by signal 5 in FIG. 8.

In an embodiment, segmenting, by the MSGin5G server (102), the data message (107) into the second set of the one or more segments (108) comprises determining a count value of total segments required to be formed from the data message (107) based on a size of the data message (107) and the maximum size of the payload supported by the destination node. Further, partitioning the data message (107) into the second set of the one or more segments (108) equal to the count value of total segments, wherein a size of each of the one or more segments (108) is lesser than or equal to the maximum size of the payload.

Furthermore, appending a segmentation set identifier value to each of the one or more segments (108), wherein the segmentation set identifier value is a unique identifier associated with the second set of the one or more segments (108). Thereafter, appending a segment sequence number to each of the one or more segments (108), wherein the segment sequence number indicates a message number associated with each of the second set of the one or more segments (108). Subsequently, appending a destination identifier value to each of the second set of the one or more segments (108). In addition, appending the count value of total segments in a first segment from the second set of the one or more segments (108). Finally, setting a value of the last segment flag to “1” in the last segment from the second set of the one or more segments (108).

The MSGin5G server (102) segments the data message (107) into second set of the one or more segments (108) by performing the steps as detailed in the step 303 of FIG. 3.

At the step 706, the method comprises sending, by the MSGin5G server (102), the second set of the one or more segments (108) to the destination node using the MSGin5G service.

The sending of the second set of the one or more segments (108) is denoted by the signal 6 in FIG. 8.

In an embodiment, the destination node detects whether a subset of segments from the second set of the one or more segments (108) are missing as detailed in the step 304 of FIG. 3. Further, the destination node performs at least one of the recovery of the one or more missing segments in the second set of the one or more segments (108) as detailed in the step 305 of FIG. 3 and the signals 1 to 4 of FIG. 6. Furthermore, the destination node performs the re-assembly of the second set of the one or more segments (108) to form the data message (107) as detailed in the step 305 of the FIG. 3.

In an embodiment, the MSGin5G server (102) receives the confirmation message comprising the segmentation set identifier value, and the result value from the destination node using the MSGin5G service. The result value indicates one of the successful reception or the un-successful reception of the data message (107) to the source node. The destination node sends the confirmation message to the MSGin5G server (102) as detailed in the step 306 of FIG. 3, depending on the application requirement.

In an embodiment, the result value indicates the un-successful reception of the data message (107) when the recovery of the one or more missing segments fails. In another embodiment, the result value indicates the un-successful reception of the data message (107) when the re-assembly of the one or more segments (108) fails.

Further, the MSGin5G server (102) sends the confirmation message to the source node using the MSGin5G service.

In an embodiment, for broadcast of the data message (107) in application-to-point communication, the destination identifier includes a broadcast area identity for which the one or more application servers (101A, 101B, . . . , 101N) wants to send data message (107).

In another embodiment, for the broadcast of the data message (107) in the point-to-application communication, the destination identifier includes a group identity for which IoT device-1 (104A) wants to send data message (107).

In an embodiment, when the destination node or the source node is a 3GPP message client or non-3GPP message client. The one or more application servers (101A, 101B, . . . , 101N) or the MSGin5G server (102) translates the data message (107) into appropriate format.

The proposed method provides a procedure for a destination node to send a confirmation message indicting the status of the data message (107) to source node. Further, method provides a procedure for the destination node to recover the one or more missing segments. Furthermore, the proposed method provides a procedure for the destination node to detect one or more missing segments and trigger a segment recovery procedure. Thereafter, the proposed method provides a procedure for the source node to detect a capability and a maximum packet size supported by access network (401) of the destination node. The proposed method provides a procedure to perform segmentation and reassembly of the data message (107) in a point-to-application, application-to-point, and in point-to-point communications. Further, the proposed method provides information elements such as the segment set identifier value, the segment sequence number, and the like with one or more segments (108) for performing the reassembly at the destination node.

The embodiments disclosed herein can be implemented using at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-15. (canceled)

16. A method performed by a source node in a wireless communication system, the method comprising:
receiving a message related to an application;
identifying whether a size of the message related to the application exceeds a maximum allowed packet size;
segmenting the message related to the application into one or more segmented messages based on the maximum allowed packet size;
transmitting, to a destination node, the one or more segmented messages; and
receiving a confirmation message associated with the message related to the application,
wherein result information included in the confirmation message is determined based on the one or more segmented messages.

17. The method of claim 16,
wherein the one or more segmented messages comprise a segmentation set identifier indicating the one or more segmented messages are associated with the message related to the application, and a segment sequence number, and
wherein a reassembly of the one or more segmented messages is performed based on the segmentation set identifier and the segment sequence number.

18. The method of claim 16, further comprising:
receiving a segment recovery request message from the destination node based on at least one missed segmented message among the one or more segmented messages;
transmitting a segment recovery acknowledgement message to the destination node; and
transmitting the at least one missed segmented message to the destination node.

19. The method of claim 18, wherein the recovery request message comprises a segmentation set identifier indicating the at least one missed segmented message is associated with the message related to the application, and a list of segment range indicating a segment sequence of the at least one missed segmented message.

20. The method of claim 18, wherein the result information of the confirmation message is determined based on whether the transmission of the at least one missed segmented message is successful.

21. The method of claim 16, wherein the confirmation message comprises a segmentation set identifier indicating the one or more segmented messages are associated with the message related to the application, and the result information indicating whether a reassembly of the one or more segmented messages is successful.

22. The method of claim 16, further comprising:
transmitting, to the destination node, an acknowledge message related to the confirmation message.

23. A method performed by a destination node in a wireless communication system, the method comprising:
receiving, from a source node, one or more segmented messages associated with a message related to an application, wherein the one or more segmented messages are segmented when a size of the message related to the application exceeds a maximum allowed packet size; and
transmitting a confirmation message associated with the message related to the application, wherein result information included in the confirmation message is determined based on the one or more segmented messages.

24. The method of claim 23,
wherein the one or more segmented messages comprise a segmentation set identifier indicating the one or more segmented messages are associated with the message related to the application, and a segment sequence number, and
wherein a reassembly of the one or more segmented messages is performed based on the segmentation set identifier and the segment sequence number.

25. The method of claim 23, further comprising:
transmitting a segment recovery request message based on at least one missed segmented message among the one or more segmented messages;
receiving a segment recovery acknowledgment message to the destination node; and
receiving the at least one missed segmented message.

26. The method of claim 25, wherein the recovery request message comprises a segmentation set identifier indicating the at least one missed segmented message is associated with the message related to the application, and a list of segment range indicating a segment sequence of the at least one missed segmented message.

27. The method of claim 25, wherein the result information of the confirmation message is determined based on whether the transmission of the at least one missed segmented message is successful.

28. The method of claim 23, wherein the confirmation message comprises a segmentation set identifier indicating the one or more segmented messages are associated with the message related to the application, and the result information indicating whether a reassembly of the one or more segmented messages is successful.

29. The method of claim 23, further comprising:
receiving, from the destination node, an acknowledge message related to the confirmation message.

30. A source node in a wireless communication system, the source nod comprising:
a communicator; and
ate least one processor coupled to the communicator and configured to:
receive a message related to an application;
identify whether a size of the message related to the application exceeds a maximum allowed packet size;
segment the message related to the application into one or more segmented messages based on the maximum allowed packet size;
transmit, to a destination node, the one or more segmented messages; and
receive a confirmation message associated with the message related to the application,
wherein result information included in the confirmation message is determined based on the one or more segmented messages.

31. The source node of claim 30,
wherein the one or more segmented messages comprise a segmentation set identifier indicating the one or more segmented messages are associated with the message related to the application, and a segment sequence number,
wherein a reassembly of the one or more segmented messages is performed based on the segmentation set identifier and the segment sequence number.

32. The source node of claim 30, the at least one processor further configured to:
receive a segment recovery request message from the destination node based on at least one missed segmented message among the one or more segmented messages;
transmit a segment recovery acknowledgement message to the destination node; and
transmit the at least one missed segmented message to the destination node.

33. The source node of claim 32, wherein the recovery request message comprises a segmentation set identifier indicating the at least one missed segmented message is associated with the message related to the application, and a list of segment range indicating a segment sequence of the at least one missed segmented message.

34. The source node of claim 30, wherein the confirmation message comprises a segmentation set identifier indicating the one or more segmented messages are associated with the message related to the application, and the result information indicating whether a reassembly of the one or more segmented messages is successful.

35. The source node of claim 30, further comprising:
transmitting, to the destination node, an acknowledge message related to the confirmation message.
